(19) United States
(12) Patent Application Publication
(10) Pub. No.: US 2015/0070525 A1
(43) Pub. Date: Mar. 12, 2015

(54) MOBILE TERMINAL AND CONTROL METHOD THEREOF

(71) Applicant: LG ELECTRONICS INC., Seoul (KR)

(72) Inventors: Ganesh RAJAGOPALAN, Bangalore (IN); Verchaswa SHARMA, Bangalore (IN)

(73) Assignee: LG ELECTRONICS INC., Seoul (KR)

(21) Appl. No.: 14/312,290

(22) Filed: Jun. 23, 2014

(30) Foreign Application Priority Data
Sep. 11, 2013 (KR) 10-2013-0109304

(51) Int. Cl. H04N 5/232

(52) U.S. Cl. CPC H04N 5/232
USPC 348/222.1

(57) ABSTRACT

A mobile terminal capable of processing video and a partial image/video of the video being captured by a camera discriminately in isolation from each other, and a control method thereof are provided. The mobile terminal includes: a camera configured to capture an image; and a controller configured to control the camera to perform a video capture function, wherein in response to a partial image/video generation event sensed while the video capture function is being performed, the controller processes at least a portion of an image captured by the camera after the sensing of the partial image/video generation event, as a partial image/video discriminated from video being continuously captured according to the video capture function.

### CROSS REFERENCE TO RELATED APPLICATIONS

Pursuant to 35 U.S.C. §119(a), this application claims the benefit of earlier filing date and right of priority to Korean Application No. 10-2013-0109304, filed on Sep. 11, 2013, the contents of which are hereby incorporated by reference herein in its entirety.

### BACKGROUND OF THE INVENTION

1. Field of the Invention

The present invention relates to a mobile terminal capable of processing video and a partial image/video of the video being captured by a camera discriminately in isolation from each other, and a control method thereof.

2. Description of the Related Art

In general, terminals may be divided into a mobile terminal and stationary terminal according to whether or not terminals are movable. In addition, mobile terminals may be divided into a handheld terminal and a vehicle mount terminal according to whether or not users can directly carry it around.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device. Efforts are ongoing to support and increase the functionality of mobile terminals. Also, a mobile terminal may communicate with at least one different mobile terminal using short-range wireless communication.

Also, in order to support and increase the functionality of terminals, software and hardware improvements, as well as changes and improvements in the structural components which form terminals may be considered. In particular, in relation to software parts of terminals, a data size that may be exchanged between terminals one time is limited in a current wireless communication system, so data exceeding a limited size should be divided so as to be transmitted or received several times or wired communication should be used, causing user inconvenience.

Users may also experience inconvenience in exchanging video data. In a case in which video captured through a camera of a terminal exceeds a limited data size, users should edit the captured video to have a limited data size in order to transmit video data to an external terminal.

Thus, in order to remove inconvenience to edit video after video capturing is finished, a terminal that may process a portion of captured video as a partial image/video that may be shared with an external terminal may be considered.

### SUMMARY OF THE INVENTION

An aspect of the present invention provides a mobile terminal capable of removing inconvenience of editing video after video capturing is finished to transmit video data to an external terminal, and a control method thereof.

Another aspect of the present invention provides a mobile terminal capable of processing at least a portion of video being continuously captured, as a partial image/video in response to a partial image/video generation event, and a control method thereof.

To achieve these and other advantages and in accordance with the purpose of the present invention, as embodied and broadly described herein, the present invention provides in one aspect a mobile terminal including: a camera configured to capture an image; and a controller configured to control the camera to perform a video capture function, wherein in response to a partial image/video generation event sensed while the video capture function is being performed, the controller may process at least a portion of an image captured by the camera after the sensing of the partial image/video generation event, as a partial image/video discriminated from video being continuously captured according to the video capture function.

According to an exemplary embodiment of the present disclosure, the partial image/video may be an image captured by the camera in response to the partial image/video generation event, or the video captured by the camera after the partial image/video generation event is sensed.

According to another exemplary embodiment of the present disclosure, the video captured according to the video capture function may be continuously captured independently from the generation of the partial image/video generation event.

According to another exemplary embodiment of the present disclosure, capturing of the partial image/video may be terminated regardless of whether the capturing of the video according to the video capture function is terminated.

According to another exemplary embodiment of the present disclosure, when sensing of the partial image/video generation event is terminated or when the partial image/video generation termination event is sensed, the capturing of the partial image/video may be terminated.

According to another exemplary embodiment of the present disclosure, when the capturing of the video according to the video capture function is terminated, the capturing of the partial image/video may also be terminated.

According to another exemplary embodiment of the present disclosure, the mobile terminal may further include: a memory configured to store the image captured by the camera, wherein the video captured according to the video capture function and the partial image/video may be stored as separate files in the memory according to a user selection.

According to another exemplary embodiment of the present disclosure, the partial image/video generation event may include a plurality of partial image/video generation events, and when the plurality of partial image/video generation events are sequentially sensed, the controller may process partial image/videos corresponding to the respective partial image/video generation events discriminately in isolation from each other.

According to another exemplary embodiment of the present disclosure, the controller may merge the plurality of partial image/videos into a single partial image/video on the basis of a user selection.

According to another exemplary embodiment of the present disclosure, the partial image/video generation event may include an event of a pre-set condition generated in the outside of the terminal.

According to another exemplary embodiment of the present disclosure, the partial image/video generation event may include an input applied to the terminal or a change generated in the terminal.

According to another exemplary embodiment of the present disclosure, the mobile terminal may further include: a display unit configured to output visual information, wherein the video captured according to the video capture function and the partial image/video may be output to the display unit.

According to another exemplary embodiment of the present disclosure, the video being continuously captured and the partial image/video may be output in an overlapping manner or may be output to different regions.

According to another exemplary embodiment of the present disclosure, a capture time of the video and a capture time of the partial image/video the display unit may be output discriminately while the video and the partial image/video are being continuously captured.

According to another exemplary embodiment of the present disclosure, the partial image/video may correspond to a partial section of the video captured according to the video capture function, and the controller may control the display unit to continuously output the video captured according to the video capture function and the partial image/video.

According to another exemplary embodiment of the present disclosure, a section corresponding to the partial image/video may be indicated together in a progress bar output to the display unit to indicate an entire section of the video captured according to the video capture function.

According to another exemplary embodiment of the present disclosure, when outputting of the partial image/video is terminated, a section of the entire section of the video captured according to the video capture function, that follows the partial image/video, is output in succession to the display unit.

To achieve these and other advantages and in accordance with the purpose of the present invention, as embodied and broadly described herein, the present invention provides in another aspect a control method of a mobile terminal, including: capturing video through a camera; sensing a partial image/video generation event that occurs while the video is continuously being captured; and processing an image captured through the camera after the event is sensed, as a partial image/video discriminated from the video.

According to an exemplary embodiment of the present disclosure, in the processing, the video may be continuously captured independently from the occurrence of the partial image/video generation event.

According to another exemplary embodiment of the present disclosure, the partial image/video may be an image captured by the camera in response to the partial image/video generation event, or the video captured by the camera after the partial image/video generation event is sensed.

According to another exemplary embodiment of the present disclosure, in the processing, storing the video captured according to the video capture function and the partial image/video as separate files in the memory according to a user selection.

According to another exemplary embodiment of the present disclosure, the partial image/video generation event may include a plurality of partial image/video generation events, and when the plurality of partial image/video generation events are sequentially sensed, partial image/videos corresponding to the respective partial image/video generation events may be processed discriminately in isolation from each other, in the processing operation.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a block diagram of a mobile terminal according to an embodiment of the present invention.

FIGS. 2A and 2B are conceptual views of communication systems in which the mobile terminal according to an embodiment of the present invention is operable.

FIG. 3A is a front perspective view of the mobile terminal related to the present invention.

FIG. 3B is a rear perspective view of the mobile terminal illustrated in FIG. 3A.

FIG. 4 is a flow chart illustrating a control method of the mobile terminal related to the present invention.

FIG. 5 is a conceptual view illustrating an operation implemented in the mobile terminal according to an exemplary embodiment of the present invention.

FIGS. 6 through 10 are conceptual views illustrating examples in which generation of a partial image/video is started or terminated as a partial image/video generation event is sensed in the mobile terminal according to an embodiment of the present invention.

FIGS. 11 through 13 are conceptual views illustrating managing a partial image/video discriminately in isolation from a video captured according to a video capture function.

FIGS. 14 and 15 are conceptual views illustrating a process of reproducing video captured according to the video capture function and a partial image/video thereof in an interworking manner.

FIGS. 16 and 17 are conceptual views illustrating making use of a partial image/video discriminately in isolation from video captured according to the video capture function.

### DETAILED DESCRIPTION OF THE INVENTION

The embodiments of the present invention will now be described with reference to the accompanying drawings, in which like numbers refer to like elements throughout although the embodiments are different, and a description of the like elements a first embodiment will be used for those of the different embodiment. In the following description, usage of suffixes such as ‘module’, ‘part’ or ‘unit’ used for referring to elements is given merely to facilitate explanation of the present invention, without having any significant meaning by itself. In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings.

Mobile terminals described in the present disclosure may include mobile phones, smart phones, notebook computers, tablet computers, digital broadcast receivers, PDAs (Personal Digital Assistants), PMPs (Portable Multimedia Player), navigation devices, slate PCs, tablet PCs, ultra-books, and the like. However, it would be understood by a person skilled in the art that the configuration according to embodiments of the present invention can be also applicable to the fixed types of terminals such as digital TVs, desk top computers, and the like, except for any elements especially configured for a mobile purpose.

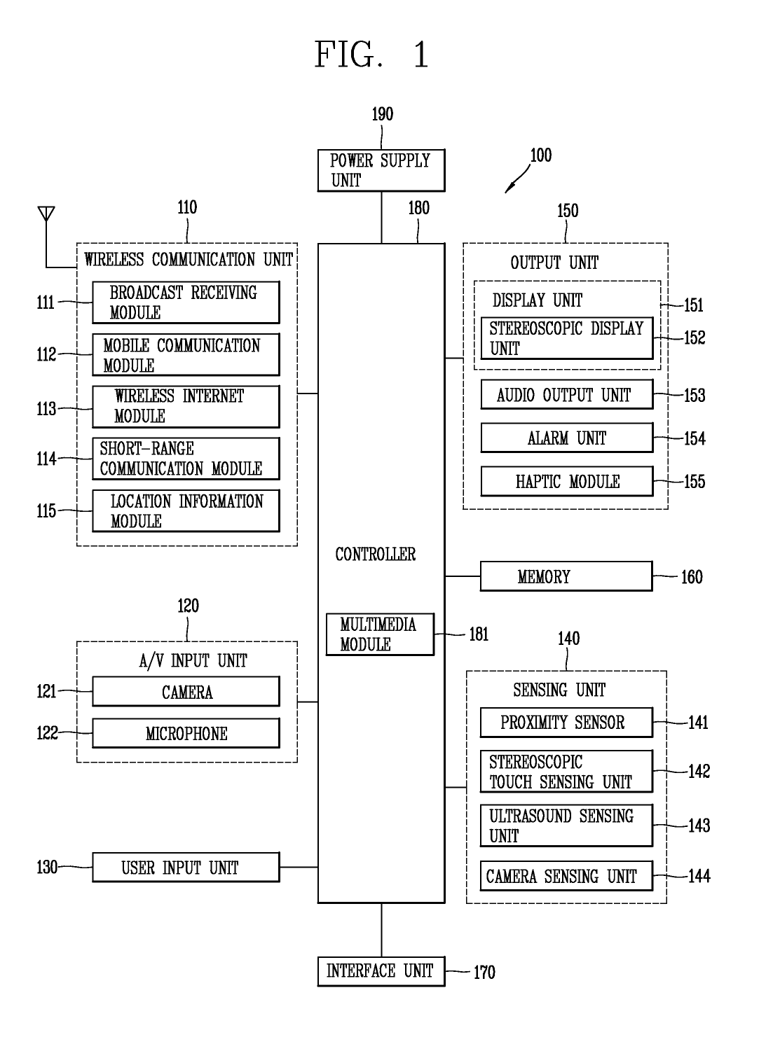

FIG. 1 is a block diagram of a mobile terminal according to an embodiment of the present invention.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile terminal as having various components, but it should be understood that implementing all of the illustrated components is not a requirement. Greater or fewer components may alternatively be implemented.

The elements of the mobile terminal will be described in detail as follows.

The wireless communication unit 110 typically includes one or more modules allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive digital broadcast signals by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160.

The mobile communication module 112 transmits and/or receives radio signals to and/or from at least one of a base station, an external terminal and a server in a mobile communication network. Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System) or a WiFi (Wireless Fidelity) module.

With reference to FIG. 1, the NV input unit 120 is configured to receive an audio or video signal. The NV input unit 120 may include a camera 121 and a microphone 122. The camera 121 processes image data of still pictures or video obtained by an image capture device in a video capturing mode or an image capturing mode. The processed image frames may be displayed on a display unit 151.

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone in a phone call mode, a recording mode, a voice recognition mode, and the like, and can process such sounds into audio data. The processed audio (voice) data may be converted for output into a format transmittable to a mobile communication base station via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 may generate input data from commands entered by a user to control various operations of the mobile terminal. The user input unit 130 may include a keypad, a dome switch, a touch pad, a jog wheel, a jog switch, and the like.

The sensing unit 140 detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The output unit 150 is configured to provide outputs in a visual, audible, and/or tactile manner (e.g., audio signal, video signal, alarm signal, vibration signal, etc.). The output unit 150 may include the display unit 151, an audio output unit 153, an alarm unit 154, a haptic module 155, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, and an e-ink display.

Some of them may be configured to be transparent or light-transmissive to allow viewing of the exterior, which may be called transparent displays. A typical transparent display may be, for example, a TOLED (Transparent Organic Light Emitting Diode) display, or the like. Through such configuration, the user can view an object positioned at the rear side of the terminal body through the region occupied by the display unit 151 of the terminal body.

The mobile terminal 100 may include two or more display units according to its particular desired embodiment. For example, a plurality of display units may be separately or integrally disposed on one surface of the mobile terminal, or may be separately disposed on mutually different surfaces.

Also, the display unit 151 may be configured as a stereoscopic display unit 152 displaying a stereoscopic image.

Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

A left image and a right image required for implementing a 3D stereoscopic image is displayed on the stereoscopic display unit 152 by a stereoscopic processing unit 152a. The stereoscopic processing unit may receive the 3D image and extract the left image and the right image, or may receive the 2D image and change it into a left image and a right image.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area of a touch object. Here, the touch object may include a finger, a touch pen, a stylus pen, a pointer, or the like.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

Referring to FIG. 1, a proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photoelectric sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor 141, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

When a touch sensor is overlaid on the stereoscopic display unit 152 in a layered manner, or when the stereoscopic display unit and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasound sensing unit 143, and a camera sensing unit 144.

The proximity sensor 141 detects the distance between a sensing object (e.g., the user's finger or a stylus) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 senses pressure applying a touch, and the applied pressure is strong, the stereoscopic touch sensing unit 142 recognizes the touch as a touch with respect to an object positioned to be farther from the touch screen toward the interior of the terminal.

The ultrasound sensing unit 143 is configured to recognize position information of the sensing object by using ultrasonic waves.

The ultrasound sensing unit 143 may include, for example, an optical sensor and a plurality of ultrasonic sensors. The optical sensor is configured to sense light, and the ultrasonic sensors may be configured to sense ultrasonic waves. Since light is very faster than ultrasonic waves, light reaches the optical sensor very earlier than ultrasonic waves reach the ultrasonic sensors. Thus, based on light as a reference signal, a position of a wave generation source may be calculated by using a time difference between a time at which light reaches the optical sensor and a time at which ultrasonic waves reach the ultrasonic sensors.

The camera sensing unit 144 includes at least one of a camera, a photo sensor, and a laser sensor.

For example, the camera and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The audio output unit 153 may convert and output as sound audio data received from the wireless communication unit 110 or stored in the memory 160 in a call signal reception mode, a call mode, a record mode, a voice recognition mode, a broadcast reception mode, and the like. Also, the audio output unit 153 may provide audible outputs related to a particular function performed by the mobile terminal 100 (e.g., a call signal reception sound, a message reception sound, etc.). The audio output unit 153 may include a speaker, a buzzer, or other sound generating device.

The alarm unit 154 outputs a signal for informing about an occurrence of an event of the mobile terminal 100. Events generated in the mobile terminal may include call signal reception, message reception, key signal inputs, a touch input etc. In addition to video or audio signals, the alarm unit 154 may output signals in a different manner, for example, to inform about an occurrence of an event. The video or audio signals may be also outputted via the audio output unit 153, so the display unit 151 and the audio output unit 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be outputted or sequentially outputted.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, when a state of the mobile terminal satisfies pre-set conditions, the controller 180 may execute a locked state for limiting an input of a control command of the user. Also, in the locked state, the controller 180 may control a locked screen displayed in the locked state on the basis of a touch input sensed through the display unit 151.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

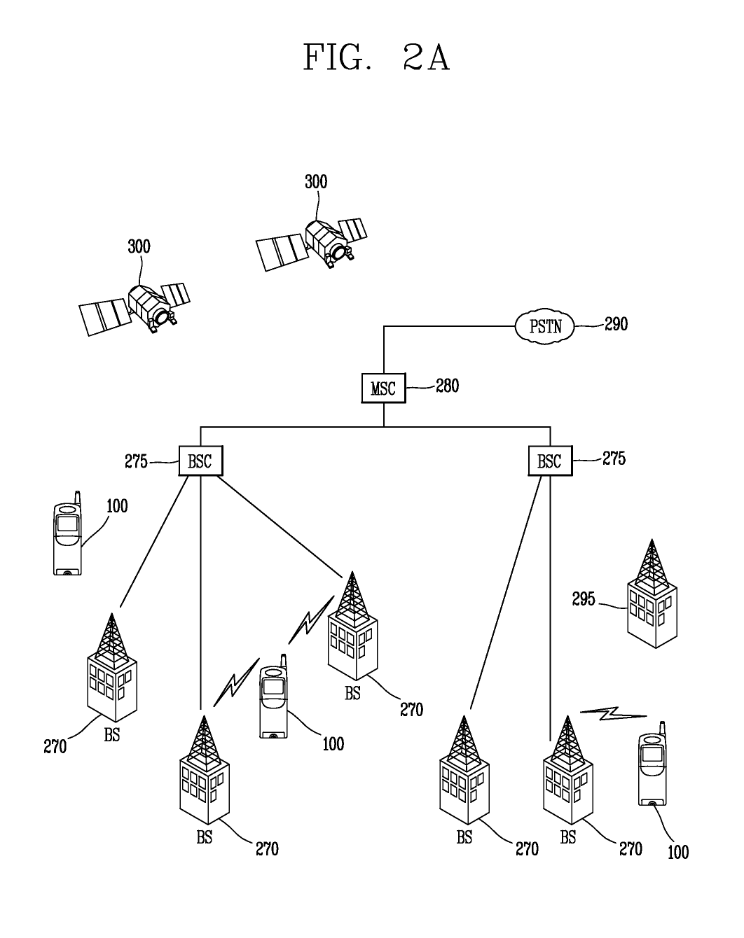

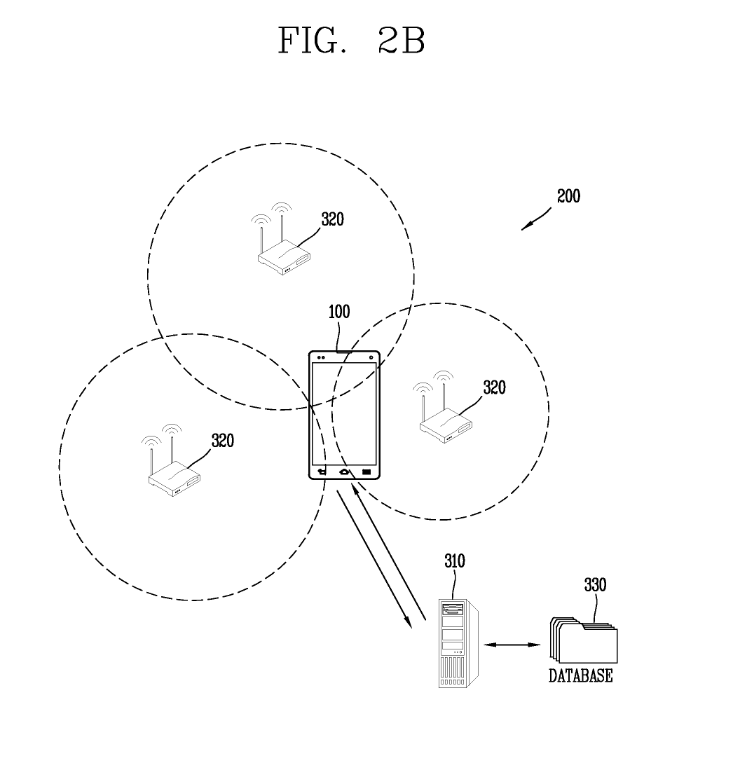

Hereinafter, a communication system implementable through the mobile terminal 100 according to an embodiment of the present invention will be described. FIGS. 2A and 2B are conceptual views of communication systems in which the mobile terminal 100 according to an embodiment of the present invention is operable.

First, referring to FIG. 2A, a communication system may use different air interfaces and/or physical layers. For example, air interfaces utilized by the communication systems include example, frequency division multiple access (FDMA), time division multiple access (TDMA), code division multiple access (CDMA), and universal mobile telecommunications system (UMTS) (in particular, long term evolution (LTE)), global system for mobile communications (GSM), and the like. As a non-limiting example, the description hereafter relates to a CDMA communication system, but such teachings apply equally to other types of systems.

Hereinafter, for the description purpose, CDMA will be described, but, obviously, the present invention is applicable to any communication system including a CDMA wireless communication system.

Referring to FIG. 2, a CDMA wireless communication system may include a plurality of mobile terminals 100, a plurality of base stations (BSs) 270, base station controllers (BSCs) 275, and a mobile switching center (MSC) 280. The MSC 280 is configured to interface with a public switch telephone network (PSTN) 290. The MSC 280 is also configured to interface with the BSCs 275, which may be coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system as shown in FIG. 2 may include a plurality of BSCs 275.

Each BS 270 may serve one or more sectors (or regions), each sector covered by an omni-directional antenna or an antenna pointed in a particular direction radially away from the BS 270. Alternatively, each sector may be covered by two or more antennas for diversity reception. Each BS 270 may be configured to support a plurality of frequency assignments, and each frequency assignment has a particular spectrum (e.g., 1.25 MHz, 5 MHz, etc).

The intersection of a sector and frequency assignment may be referred to as a CDMA channel. The BS 270 may also be referred to as base station transceiver subsystems (BTSs) or other equivalent terms. In such case, the term “base station” may be used to collectively refer to a single BSC 275 and at least one BS 270. The base station may also be referred to as a “cell site”. Alternatively, individual sectors of a particular BS 270 may be referred to as a plurality of cell sites.

As shown in FIG. 2A, a broadcasting transmitter (BT) 295 transmits a broadcast signal to the mobile terminals 100 operating within the system. The broadcast receiving module 111 as shown in FIG. 1 is provided at the terminal 100 to receive broadcast signals transmitted by the BT 295.

Also, in FIG. 2A, several global positioning systems (GPS) satellites 300 are shown. The satellites 300 help locate at least one of a plurality of terminals 100. In FIG. 2, several satellites 300 are depicted, but it is understood that useful positioning information may be obtained with any number of satellites. The GPS module 115 as shown in FIG. 1 is typically configured to cooperate with the satellites 300 to obtain desired positioning information. Instead of or in addition to GPS tracking techniques, other technologies that may track the location of the mobile terminals may be used. In addition, at least one of the GPS satellites 300 may selectively or additionally handle satellite DMB transmissions.

As one typical operation of the wireless communication system, the BSs 270 receive reverse-link signals from various mobile terminals 100. The mobile terminals 100 typically engaging in calls, messaging, and other types of communications. Each reverse-link signal received by a particular base station 270 is processed within the particular BS 270. The resulting data is forwarded to an associated BSC 275. The BSC provides call resource allocation and mobility management functionality including the coordination of soft handoff procedures between BSs 270. The BSCs 275 also route the received data to the MSC 280, which provides additional routing services for interfacing with the PSTN 290. Similarly, the PSTN 290 interfaces with the MSC 280, the MSC interfaces with the BSCs 275, and the BSCs 275 in turn control the BSs 270 to transmit forward-link signals to the mobile terminals 100.

Next, a method of acquiring the location information of a mobile terminal using a WiFi (Wireless Fidelity) positioning system (WPS) will be described with reference to FIG. 2B.

The WiFi positioning system (WPS) 300 refers to a location determination technology based on a wireless local area network (WLAN) using WiFi as a technology for tracking the location of the mobile terminal 100 using a WiFi module provided in the mobile terminal 100 and a wireless access point 320 for transmitting and receiving to and from the WiFi module.

The WiFi positioning system 300 may include a WiFi location determination server 310, a mobile terminal 100, a wireless access point (AP) 320 connected to the mobile terminal 100, and a database 330 stored with any wireless AP information.

The WiFi location determination server 310 extracts the information of the wireless AP 320 connected to the mobile terminal 100 based on a location information request message (or signal) of the mobile terminal 100. The information of the wireless AP 320 may be transmitted to the WiFi location determination server 310 through the mobile terminal 100 or transmitted to the WiFi location determination server 310 from the wireless AP 320.

The information of the wireless AP extracted based on the location information request message of the mobile terminal 100 may be at least one of MAC address, SSID, RSSI, channel information, privacy, network type, signal strength and noise strength.

The WiFi location determination server 310 receives the information of the wireless AP 320 connected to the mobile terminal 100 as described above, and compares the received wireless AP 320 information with information contained in the pre-established database 330 to extract (or analyze) the location information of the mobile terminal 100.

On the other hand, referring to FIG. 2B, as an example, the wireless AP connected to the mobile terminal 100 is illustrated as a first, a second, and a third wireless AP 320. However, the number of wireless APs connected to the mobile terminal 100 may be changed in various ways according to a wireless communication environment in which the mobile terminal 100 is located. When the mobile terminal 100 is connected to at least one of wireless APs, the WiFi positioning system 300 can track the location of the mobile terminal 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the mobile terminal 100 from the database 330 to extract the location information matched to the searched wireless AP, thereby extracting the location information of the mobile terminal 100.

Furthermore, the extracted location information of the mobile terminal 100 may be transmitted to the mobile terminal 100 through the WiFi location determination server 310, thereby acquiring the location information of the mobile terminal 100.

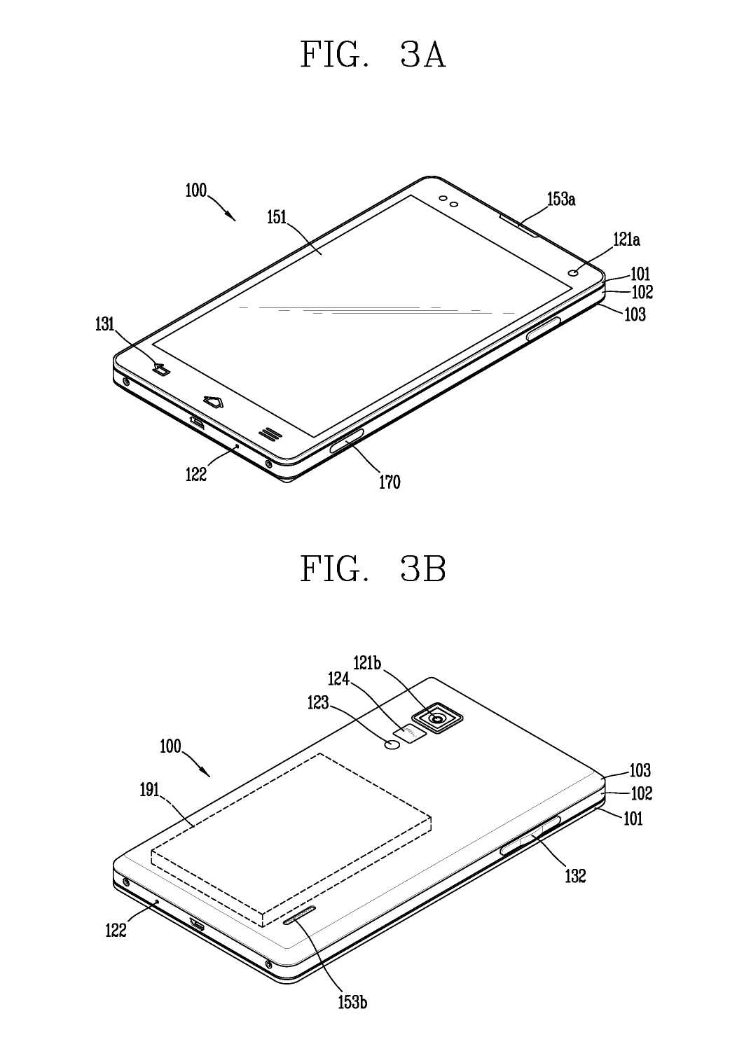

FIG. 3A is a front perspective view illustrating an example of the mobile terminal 100 associated with the present disclosure.

The mobile terminal 100 disclosed herein is provided with a bar-type terminal body. However, the present invention may not be limited to this, but also may be applicable to various structures such as watch type, clip type, glasses type or folder type, flip type, swing type, swivel type, or the like, in which two and more bodies are combined with each other in a relatively movable manner.

The terminal body includes a case (casing, housing, cover, etc.) forming the appearance of the terminal. In this embodiment, the case may be divided into a front case 101 and a rear case 102. Various electronic components are incorporated into a space formed between the front case 101 and the rear case 102. At least one middle case may be additionally disposed between the front case 101 and the rear case 102, and a battery cover 103 for covering the battery 191 may be detachably configured at the rear case 102.

The cases may be formed by injection-molding a synthetic resin or may be also formed of a metal, for example, stainless steel (STS), titanium (Ti), or the like.

A display unit 151, a first audio output unit 153a, a first camera 121a, a first manipulating unit 131 and the like may be disposed on a front surface of the terminal body, and a microphone 122, an interface unit 170, a second manipulating unit 132 and the like may be provided on a lateral surface thereof.

The display unit 151 may be configured to display (output) information being processed in the mobile terminal 100. The display unit 151 may include at least one of a liquid crystal display (LCD), a thin film transistor-liquid crystal display (TFT-LCD), an organic light emitting diode (OLED) display, a flexible display, a 3-dimensional (3D) display, and an e-ink display.

The display unit 151 may include a touch sensing means to receive a control command by a touch method. When a touch is made to any one place on the display unit 151, the touch sensing means may be configured to sense this touch and enter the content corresponding to the touched place. The content entered by a touch method may be a text or numerical value, or a menu item capable of indication or designation in various modes.

The touch sensing means may be formed with transparency to allow visual information displayed on the display unit 151 to be seen, and may include a structure for enhancing the visibility of a touch screen at bright places. Referring to FIG. 3A, the display unit 151 occupies a most portion of the front surface of the front case 101.

The first audio output unit 153a and the first camera 121a are disposed in a region adjacent to one of both ends of the display unit 151, and the first manipulation input unit 131 and the microphone 122 are disposed in a region adjacent to the other end thereof. The second manipulation unit 132 (refer to FIG. 3B), the interface 170, and the like, may be disposed on a lateral surface of the terminal body.

The first audio output unit 153a may be implemented in the form of a receiver for transferring voice sounds to the user's ear or a loud speaker for outputting various alarm sounds or multimedia reproduction sounds.

It may be configured such that the sounds generated from the first audio output unit 153a are released along an assembly gap between the structural bodies. In this case, a hole independently formed to output audio sounds may not be seen or hidden in terms of appearance, thereby further simplifying the appearance of the mobile terminal 100. However, the present invention may not be limited to this, but a hole for releasing the sounds may be formed on the window.

The first camera 121a processes video frames such as still or moving images obtained by the image sensor in a video call mode or capture mode. The processed video frames may be displayed on the display unit 151.

The user input unit 130 is manipulated to receive a command for controlling the operation of the mobile terminal 100. The user input unit 130 may include a first and a second manipulation unit 131, 132. The first and the second manipulation unit 131, 132 may be commonly referred to as a manipulating portion, and any method may be employed if it is a tactile manner allowing the user to perform manipulation with a tactile feeling such as touch, push, scroll or the like.

In the present drawing, it is illustrated on the basis that the first manipulation unit 131 is a touch key, but the present disclosure may not be necessarily limited to this. For example, the first manipulation unit 131 may be configured with a mechanical key, or a combination of a touch key and a mechanical key.

The content received by the first and/or second manipulation units 131, 132 may be set in various ways. For example, the first manipulation unit 131 may be used to receive a command such as menu, home key, cancel, search, or the like, and the second manipulation unit 132 may receive a command, such as controlling a volume level being outputted from the first audio output unit 153a, or switching into a touch recognition mode of the display unit 151.

The microphone 122 may be formed to receive the user's voice, other sounds, or the like. The microphone 122 may be provided at a plurality of places, and configured to receive stereo sounds.

The interface unit 170 serves as a path allowing the mobile terminal 100 to exchange data with external devices. For example, the interface unit 170 may be at least one of a connection terminal for connecting to an earphone in a wired or wireless manner, a port for near field communication (for example, an Infrared Data Association (IrDA) port, a Bluetooth port, a wireless LAN port, and the like), and a power supply terminal for supplying power to the mobile terminal 100. The interface unit 170 may be implemented in the form of a socket for accommodating an external card such as Subscriber Identification Module (SIM) or User Identity Module (UIM), and a memory card for information storage.

FIG. 3B is a rear perspective view illustrating mobile terminal 100 illustrated in FIG. 3A.

Referring to FIG. 3B, a second camera 121b may be additionally mounted at a rear surface of the terminal body, namely, the rear case 102. The second camera 121b has an image capturing direction, which is substantially opposite to the direction of the first camera unit 121a (refer to FIG. 3A), and may have a different number of pixels from that of the first camera unit 121a.

For example, it is preferable that the first camera 121a has a relatively small number of pixels enough not to cause difficulty when the user captures his or her own face and sends it to the other party during a video call or the like, and the second camera 121b has a relatively large number of pixels since the user often captures a general object that is not sent immediately. The first and the second camera 121a, 121b may be provided in the terminal body in a rotatable and pop-up manner.

A flash 123 and a mirror 124 may be additionally disposed adjacent to the second camera 121b. The flash 123 illuminates light toward an object when capturing the object with the second camera 121b. The mirror 124 allows the user to look at his or her own face, or the like, in a reflected way when capturing himself or herself (in a self-portrait mode) by using the second camera 121b.

A second audio output unit 153b may be additionally disposed at a rear surface of the terminal body. The second audio output unit 153b together with the first audio output unit 153a (refer to FIG. 3A) can implement a stereo function, and may be also used to implement a speaker phone mode during a phone call.

An antenna (not shown) for receiving broadcast signals may be additionally disposed at a lateral surface of the terminal body in addition to an antenna for making a phone call or the like. The antenna constituting part of the broadcast receiving module 111 (refer to FIG. 1) may be provided in the terminal body in a retractable manner.

A power supply unit 190 (refer to FIG. 1) for supplying power to the mobile terminal 100 may be mounted on the terminal body. The power supply unit 190 may be incorporated into the terminal body, or may include a battery 191 configured in a detachable manner on the outside of the terminal body. According to the drawing, it is illustrated that the battery cover 103 is combined with the rear case 102 to cover the battery 191, thereby restricting the battery 191 from being released and protecting the battery 191 from external shocks and foreign substances.

Hereinafter, the mobile terminal 100 that generates a partial image/video, while capturing video by using the camera 121, and discriminately processes the generated partial image/video from the video being continuously captured, and a control method thereof will be described.

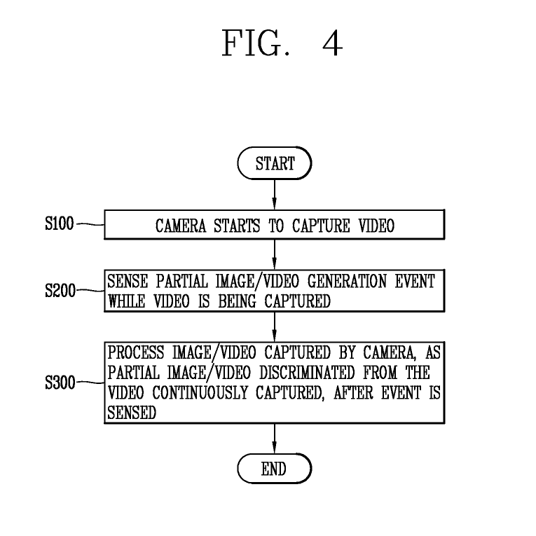

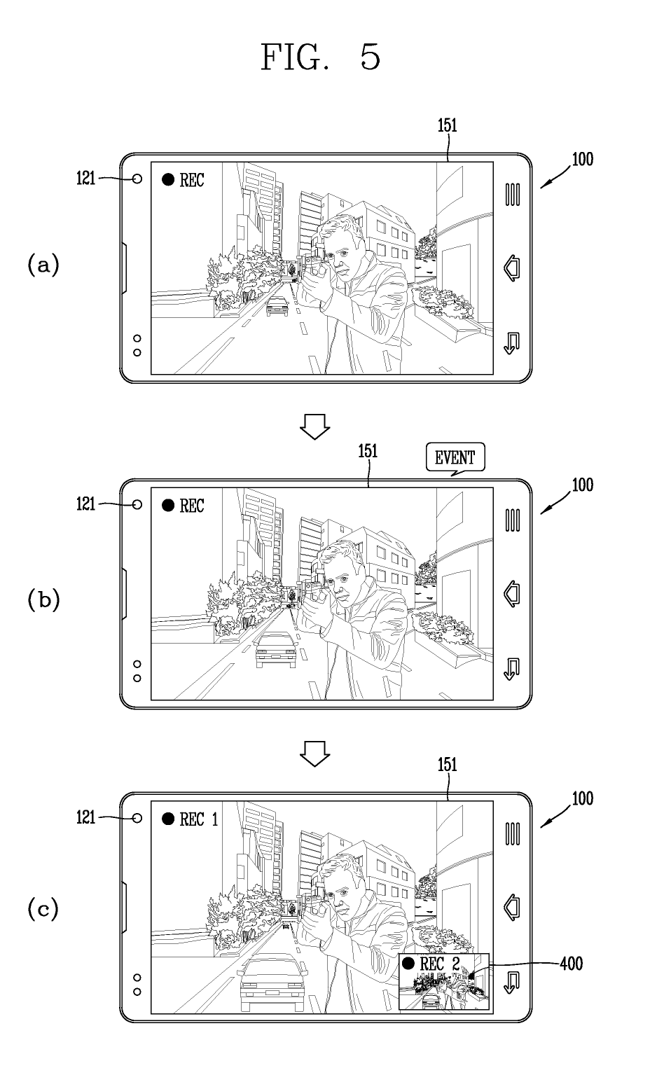

FIG. 4 is a flow chart illustrating a control method of the mobile terminal 100 related to the present invention. FIG. 5 is a conceptual view illustrating an operation implemented in the mobile terminal 100 according to an exemplary embodiment of the present invention.

Referring to FIG. 4, the camera 121 of the mobile terminal 100 starts to capture video (S100). The controller controls the camera 121 to perform a video capturing function.

Video capturing may start according to a user manipulation. For example, capturing video may start by executing an application related to the camera 121 of the terminal 100, or may start while the terminal 100 is communicating with a different terminal by using a mobile messenger or any other application or while the terminal 100 is exchanging data with an external server.

Referring to (a) of FIG. 5, the mobile terminal 100 includes a camera 121, a display unit 151, and a controller. The camera 121 includes a front camera 121 and a rear camera 121, and an image is captured by any one of the cameras 121. Video may be captured by the camera 121 ma the captured video may be output to the display unit 151 in real time.

Referring back to FIG. 4, a partial image/video generation event is sensed while video is being captured. (S200). Referring to (b) of FIG. 5, when the partial image/video generation event occurs while video is being captured, the sensor provided in the terminal 100 senses the partial image/video generation event.

The partial image/video generation event may be an event under a pre-set condition occurring in the outside of the terminal 100, or may be an input applied to the terminal 100 or related to a change generated in the terminal 100. For example, a sudden change in a sound while video is being capture may correspond to an event under a pre-set condition occurring in the outside of the terminal 100. A user input of a control command through an input unit of the terminal 100 correspond to an input applied to the terminal 100. Also, a change in a video capture angle of the camera 121 correspond to an event related to a change generated in the terminal 100.

The partial image/video generation event may be sensed by a sensing unit (or a sensor) provided in the terminal 100, and types of the sensing unit for sensing the partial image/video generation event may vary according to attributes of the partial image/video generation event. For example, a change in a sound generated in the outside of the terminal 100 may be sensed by a microphone, and a change in light may be sensed by the camera 121 or an illuminance sensor. An input applied to the terminal 100 may be sensed by a user input unit provided in the terminal 100 or a touch sensing unit provided in a touch screen. An event related to a change generated in the terminal 100 may be sensed by a gyroscope sensor, a geomagnetic sensor, an accelerometer, a gravity sensor, and the like.

For example, when a sound is changed in the outside, the sound is input to the terminal 100 through the microphone, and the terminal 100 may recognize it as a generation of a partial image/video generation event. When a video capture angle of the camera 121 is changed, the accelerometer may sense the change and the terminal 100 may recognize it as a generation of a partial image/video generation event.

Finally, after the partial image/video generation event is sensed, an image captured through the camera 121 is processed as partial video such that it is differentiated from the video being continuously captured (S300).

The camera captures video according to a video capture function controlled by the controller, and the partial video is discriminated from the video captured based on the video capture function. The partial image/video may be an image captured by the camera 121 according to the occurrence of the partial image/video generation event or video captured by the camera 121 after the partial image/video generation event is sensed.

The partial image/video generation event may be plural, rather than one, and a plurality of partial image/videos may be generated in response to occurrence of each partial image/video generation event. When the sensor that senses a partial image/video generation event senses a plurality of partial image/video generation events, the controller of the terminal 100 discriminately processes partial image/videos corresponding to each partial image/video generation event.

In the following description, in order to discriminate between video captured according to the video capture function and a partial image/video, the video captured according to the video capture function will be referred to as an ‘entire video’, and an image and video included in partial image/video, will be referred to as a ‘partial still image’ and a ‘partial video’. Also, a ‘partial image/video’ will be used as a term covering both a ‘partial still image’ and a ‘partial video’.

An entire video and a partial image/video are captured by the same camera 121, and the partial image/video is captured while the entire video is being captured. Thus, the entire video includes the partial image/video, and a partial still image corresponds to a moment of the entire video, and a partial video corresponds to a partial section of the entire video.

Referring to (c) of FIG. 5, it is illustrated that at least a portion of an image captured by the camera 121 is processed as a partial image/video discriminated from the entire video, after the partial image/video generation event is sensed. Although the entire video and the partial image/video are captured by the same camera 121, they are processed discriminately, so the partial image/video is generated in isolation from the generation of the entire video.

Thus, as illustrated in (c) of FIG. 5, although the entire captured image is output to the greater part of the display unit 151, a partial captured image may be output to at least a region of the display unit 151 such that it overlaps with the entire captured image. As illustrated, in order to discriminate between the entire video and the partial image/video in the display unit 151, the entire video may be indicated by REC1 and the partial image/video may be indicated by REC2.

The partial image/video is processed discriminately in isolation from the entire video, regardless of whether the entire video is being continuously captured or whether capturing of the entire video has been completed. Hereinafter, processing of a partial image/video discriminated from an entire video will be described. Processing of a partial image/video discriminated from an entire video will be described by dividing it into operations of generating a partial image/video, managing the partial image/video, reproducing the partial image/video, and transmitting and receiving the partial image/video to a terminal or a server in isolation from the entire video.

First, referring to the operation of generating a partial image/video, when a generated partial image/video generation event is sensed while the entire video is being continuously captured, the partial image/video starts to be captured, while the entire video is continuously captured independently apart from the generated partial image/video generation event.

The capturing of the partial still image may be one-off capturing, but may be performed several times according to pre-set conditions. For example, when a generation of the partial image/video generation event is sensed in the terminal 100, a partial still image may be captured by using the camera 121, which has been used for capturing the entire video, and in this case, partial still images may be continually captured at predetermined time intervals or may be captured whenever the camera 121 is brought into focus on a target according to pre-set conditions. Capturing the partial still image may be terminated when the partial image/video generation event becomes extinct, when termination of the partial image/video generation event is sensed, or when a pre-set period of time or a pre-set number arrives.

The partial video starts to be captured while the entire video is being continuously captured, and capturing the partial video may be terminated regardless of termination of capturing of the entire video. When capturing of the entire video is terminated, capturing the partial image/video may be terminated according to a setting. However, since the controller discriminately processes the entire video and the partial image/video, although capturing of the entire video is terminated, capturing of the partial video may not be terminated. Capturing of the partial video may be terminated while the entire video is being continuously captured, or may be terminated after the capturing of the entire video is terminated. The capturing of the partial video may be terminated when extinction of the partial image/video generation event is sensed or when generation of the partial image/video generation event is sensed. Also, the capturing of the partial video may be terminated when it meets a pre-set reference. Here, for example, the pre-set reference may be a pre-set partial video capturing period of time or a data size.

Referring to the operation of managing a partial image/video, the terminal 100 may include a memory for storing an image captured by the camera 121 and a partial image/video may be stored in the memory as a separate file in isolation from an entire video.

A partial image/video which has been completely captured may be automatically stored in the memory or may be stored according to a user selection. In the case in which the partial image/video is stored on the basis of a user selection, before or after the capturing of the entire video is terminated, a screen inquiring whether to store the partial image/video may be output to the display unit 151, and when a user selection for storing the partial image/video is input, the partial image/video may be stored as a file in isolation from the entire video in the memory.

After capturing of the partial image/video and the entire video is completely terminated, a screen inquiring whether to store the partial image/video and the entire video may be output to the display unit 151. The user may store both the partial image/video and the entire video or only any one of them according to a user selection. Alternatively, the user may include the partial image/video in the entire video and store the same.

Including the partial image/video in the entire video refers to including information of the partial image/video in the entire video, rather than generating the partial image/video as a file separated from the entire video. In this case, since the information of the partial image/video is included in the entire video, the user may retrieve partial image/video information from the entire video stored in the memory to use the same any time, and generate a file of only the partial image/video discriminated from the entire video from the partial image/video information.

A file of the partial image/video stored separately from the entire video may be used separately from a file of the entire video. In this case, the partial image/video may include information of the entire video. Thus, although the file of the entire video and the file of the partial image/video are separate files, they include mutual information (or information regarding the other), and a relationship between the entirety and a portion may be shown.

In a case in which a plurality of partial image/videos are related to a single entire video, the respective partial image/videos are managed discriminately. Each of the partial image/videos may include information of the entire video and include information of a different partial image/video. For example, in a single entire video, a first partial image/video and a second partial image/video may be displayed and include information regarding the other partial image/video each other, respectively. Also, the first and second partial image/videos may be merged into a single partial image/video on the basis of a user selection.

The operation of reproducing a partial image/video will be described. The purpose of the terminal to capture video is to use and share visual information and eventually record and reproduce (or play) video as data. Reproducing video refers to outputting visual information from the display unit 151 and outputting auditory information from a speaker, an earphone, or the like, such that a user may recognize contents of the captured video through five senses.

A partial image/video may be processed separately from an entire video and may be stored as a file separate from the entire video, so the partial image/video may be reproduced regardless of reproduction of the entire video. Only the entire video may be reproduced or only the partial image/video may be reproduced according to a user selection.

The partial image/video may include information regarding the entire video and the entire video may include information regarding the partial image/video, so reproducing the partial image/video and reproducing the entire video may interwork. For example, in a case in which a partial image/video corresponds to a partial section of the entire video and the partial image/video is reproduced ahead of the entire video, when reproducing of the partial image/video is terminated, the entire video may be reproduced in succession. A reproduction section of the entire video may be reproduced from the beginning, or may be reproduced in succession to a section in which reproducing of the partial image/video is terminated.

Also, while the entire video is being reproduced, a progress bar indicating a reproduction section of the entire video may be output to the display unit 151, and the section corresponding to the partial image/video may be displayed together in the progress bar. Accordingly, the user may recognize the presence of the partial image/video related to the entire video through the progress bar of the entire video.

Finally, transmission and reception of data related to a partial image/video, separately from an entire video, to a terminal or a server will be described.

A partial image/video may be stored as a file separate from an entire video in the memory, and data related to the partial image/video may be transmitted, in isolation from the entire video, to a terminal or a server even before being stored in the memory. For example, only the partial image/video may be transmitted by using a mobile messenger to a terminal user, in isolation from the entire video, or may be transmitted to a server such as Blog, or the like, so as to be uploaded. Transmitting the data related to the partial image/video to a terminal or a server is unrelated to termination of capturing of the entire video, and thus, so the data related to the partial image/video may be transmitted to the terminal or the server before capturing of the entire video is terminated.

A size of the data related to the partial image/video is smaller than that of data related to the entire video, so it may be advantageously transmitted to the terminal or the server. In many cases, current wireless communication systems limit a magnitude of data that may be transmitted by using wireless communication, so data exceeding the limited size may be dividedly transmitted or may be transmitted by using wired communication. Thus, completely captured video needs to be adjusted to have a size transmittable through a wireless communication system, rather than being immediately transmitted, causing user inconvenience. In an exemplary embodiment of the present invention, data of a partial image/video may be generated by limiting a size thereof according to a setting, and thus, a completely captured partial image/video may be transmitted to a terminal or a server by using a wireless communication system without having to perform an editing process. Thus, a current wireless communication system and a technical limitation of the related art may be overcome and user convenience may be enhanced.

Transmitting a partial image/video to a terminal or a server may be determined by a user selection. In particular, data related to a partial image/video may be transmitted to a terminal or a server at the same time when the entire video is being captured even before the capturing of the entire video is terminated.

Hereinafter, specific embodiments of the mobile terminal 100 and a control method thereof as described above with reference to FIGS. 4 and 5 will be described.

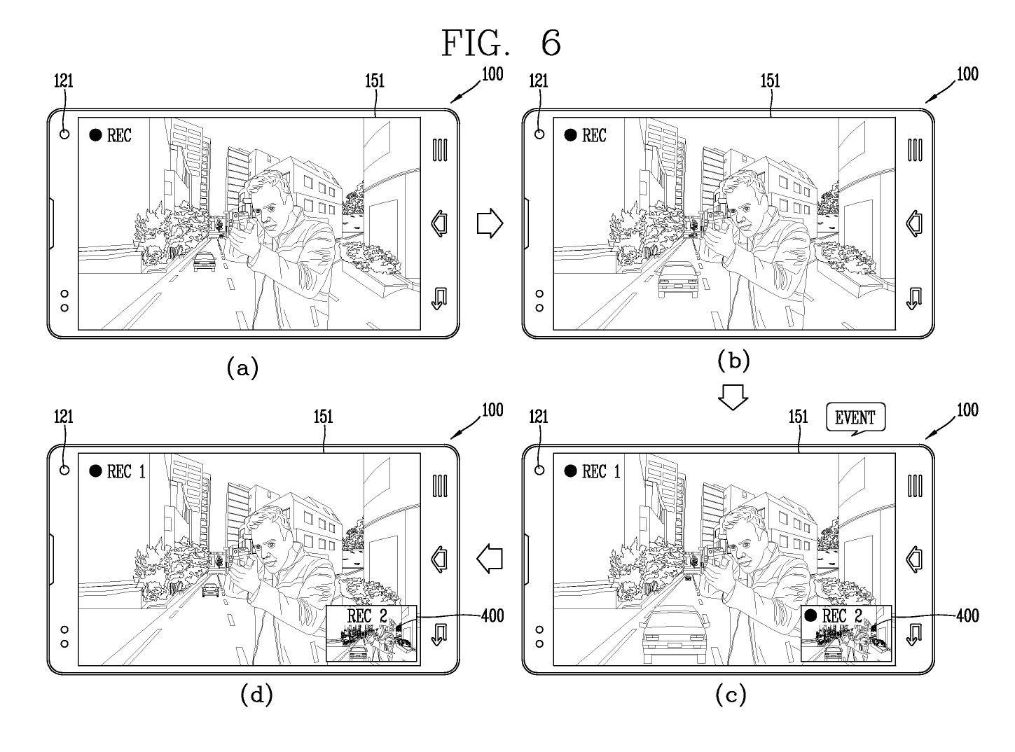

FIGS. 6 through 10 are conceptual views illustrating examples in which generation of a partial image/video is started or terminated as a partial image/video generation event is sensed in the mobile terminal 100 according to an embodiment of the present invention.

FIG. 6 is a view illustrating an embodiment in which a partial image/video starts to be generated in the terminal in response to a partial image/video generation event that occurs in the outside of the terminal 100.

Referring to (a) of FIG. 6, video (entire video) is captured by the camera 121, and the video captured by the camera 121 is output to the display unit 151 in real time.

Referring to (b) of FIG. 6, when a partial image/video generation event occurs in the outside of the terminal 100, the sensor provided in the terminal 100 senses the partial image/video generation event.

The partial image/video generation event occurring in the outside of the terminal 100 includes an event related to a sound. For example, in a case in which the volume of a sound input through the microphone of the terminal 100 is suddenly turned up while video is being captured, it may be sensed as a partial image/video generation event.

In another example, a reference sound related to a sound such as shouts in sports, a song at a birthday party, a cry of a baby, and the like, may be stored in the terminal 100, and when a sound similar to the reference sound is sensed in the outside of the terminal 100, a partial image/video may be automatically started to be generated.

The partial image/video generation event that occurs in the outside of the terminal 100 may include an event related to brightness. In a case in which brightness of a location in which image capturing is performed by the camera 121 brightens or darkens suddenly, it may be sensed as a partial image/video generation event. For example, when a lamp is turned off in an indoor area at a birthday party, brightness of light is reduced suddenly and it may be sensed as a partial image/video generation event.

Referring to (c) of FIG. 6, a partial image/video starts to be generated in response to the partial image/video generation event, and an indicator indicating that generation of the partial image/video starts is output to a region of the display unit 151. When the partial image/video generation event generated in the outside of the terminal 100 becomes extinct or when a partial image/video generation termination event is sensed, the generation of the partial image/video is terminated.

Referring to (d) of FIG. 6, since the partial image/video generation event becomes extinct and thus is not sensed any longer, an indicator indicating that the generation of the partial image/video is terminated is output to the display unit 151.

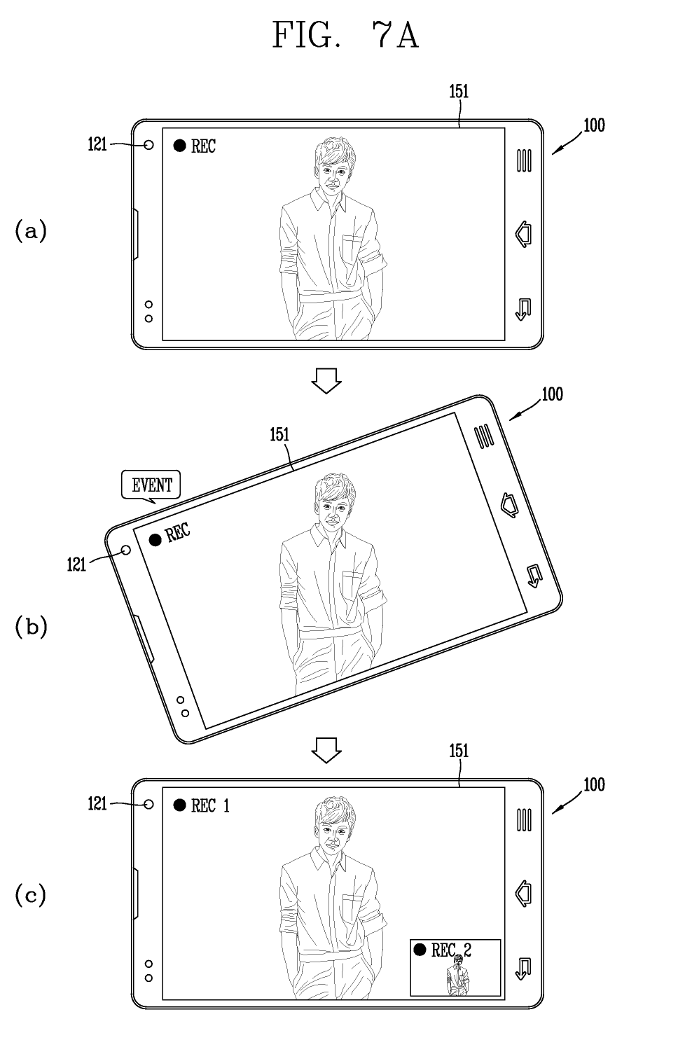

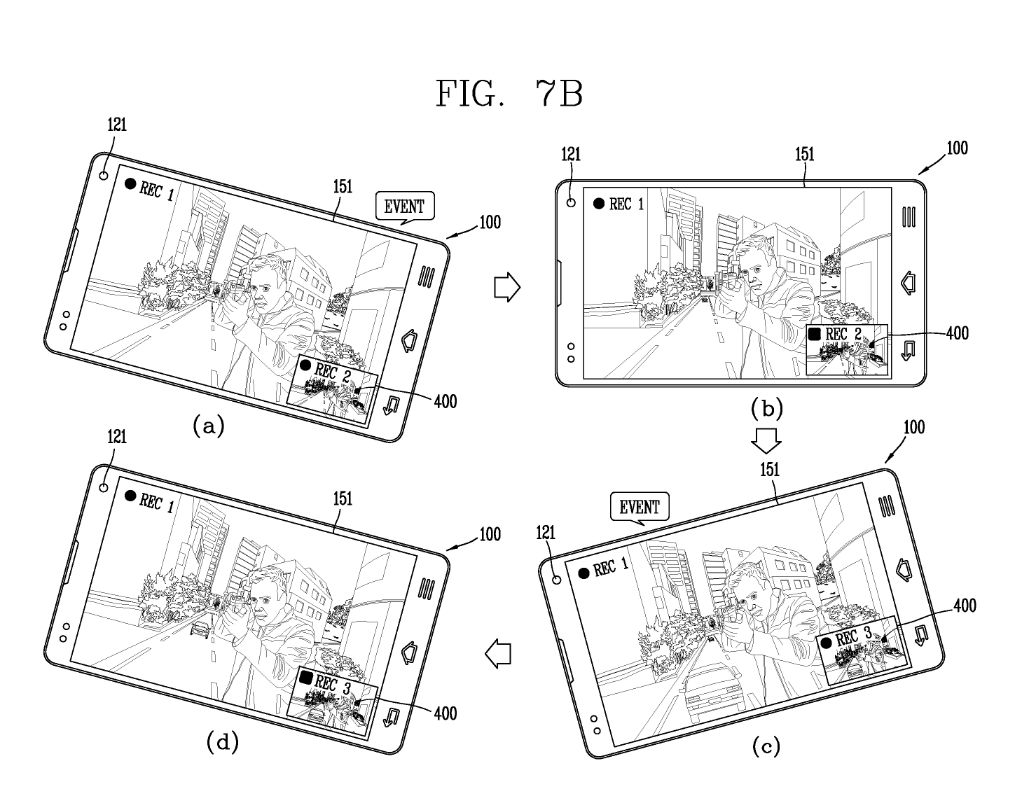

FIGS. 7A and 7B illustrate an embodiment in which a change generated in the terminal 100 is sensed as a partial image/video generation event and a partial image/video starts to be generated in the terminal 100.

First, referring to (a) of FIG. 7A, video (an entire video) is captured by the camera 121, and the video captured by the camera 121 is output to the display unit 151 in real time.

Referring to (b) of FIG. 7A, a change is generated in the terminal while video is continuously being captured, and the terminal 100 senses it as a partial image/video generation event. The change generated in the terminal 100 includes tilting of the terminal 100 at an angle equal to or greater than a pre-set angle as illustrated in (b) of FIG. 7A. The sensor provided in the terminal 100 senses that the terminal is sloped at an angle equal to or greater than the pre-set angle, and the controller recognizes it as occurrence of a partial image/video generation event.

In another example, a change generated in the terminal 100 may include a change in a camera 121 angle to be equal to or greater than a pre-set value or a sudden change in a capture direction of the camera 121, a change in a position of the terminal 100 as the user who holds the terminal 100 moves, and the like.

Referring to (c) of FIG. 7A, as the partial image/video generation event is sensed, a partial image/video starts to be generated in the terminal 100 and an indicator indicating the generation of the partial image/video is output to the display unit 151.

FIG. 7B illustrates an embodiment in which generation of a partial image/video starts or is terminated as a change generated in the terminal 100 is sensed as a partial image/video generation event, and when a plurality of partial image/video generation events occur, the entire video and partial image/videos are process discriminately in isolation from each other.

Referring to (a) of FIG. 7B, while the generation of the partial image/video is continued in succession to (c) of FIG. 7A, the terminal 100 is sloped rightwardly to have a level equal to or greater than a pre-set value. In comparison to the case of FIG. 7A in which the terminal 100 is sloped leftwardly, it can be seen that the terminal 100 is sloped in the opposite side. Such a change generated in the terminal 100 may be set in advance in the terminal 100. For example, tilting of the terminal 100 in any one direction may be set as a generation of a partial image/video generation event, and tilting of the terminal 100 in the other direction may be set as a generation of a partial image/video generation termination event.

Referring to (b) of FIG. 7B, as the sensor senses that the terminal 100 is sloped in the opposite direction (i.e., in the leftward direction) of the direction in which the partial image/video generation event occurs, the generation of the partial image/video is terminated. Although the generation of the partial image/video is terminated, capturing of the entire video may be continued. The capturing of the entire video may be continued regardless of occurrence of the partial image/video generation event or occurrence of the partial image/video generation termination event.

Referring to (c) of FIG. 7B, as the terminal 100 tilts again, it is generated as occurrence of the partial image/video generation event and a second partial image/video starts to be generated while the single entire video is continuously being captured. Each of the partial image/videos may be classified as a first partial image/video and a second partial image/video and the number of partial image/videos may be increased.

Referring to (d) of FIG. 7B, a the terminal 100 tilts in the opposite direction, it is sensed as a partial image/video generation termination event and the generation of the partial image/video is terminated.

A plurality of partial image/videos may be sequentially generated as illustrated but it does not mean that after generation of any one partial image/video is terminated, the other partial image/video starts to be generated. Namely, in case of a plurality of partial image/videos, a second partial image/video may start to be generated before generation of the first partial image/video is terminated. Also, even though the first partial image/video starts to be generated before the second partial image/video, the generation of the second partial image/video may be first terminated and the generation of the first partial image/video may be terminated later.

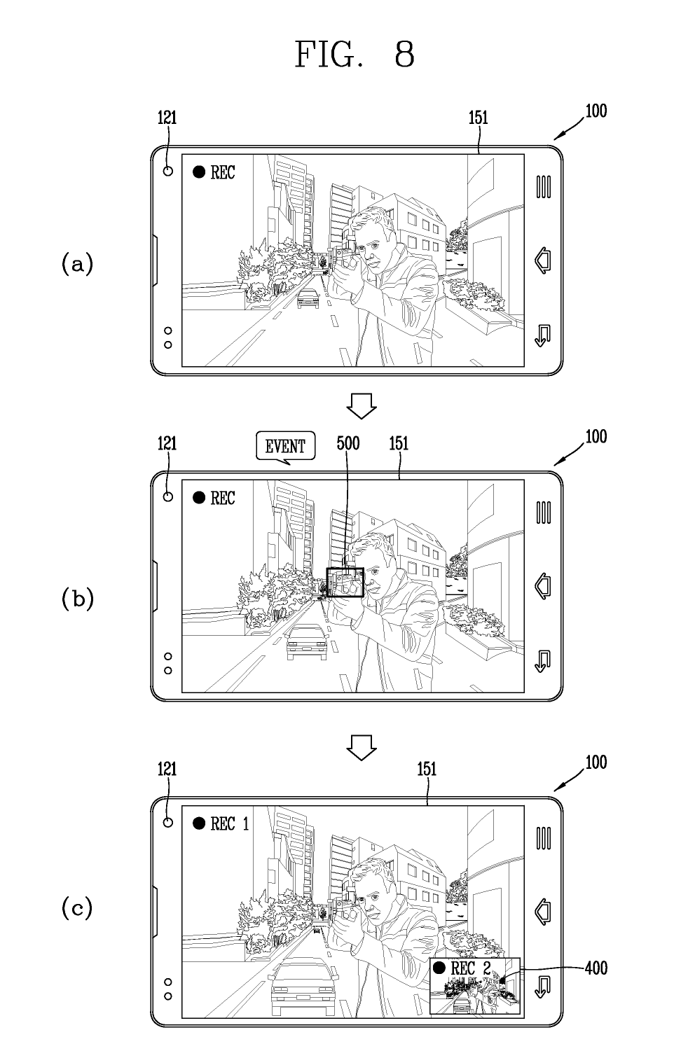

FIG. 8 illustrates an embodiment in which a partial image/video starts to be generated in the terminal 100 as a target imaged by the camera 121 is sensed.

Referring to (a) of FIG. 8, video (an entire video) is captured by the camera 121 and the video captured by the camera 121 is output to the display unit 151 in real time.

Referring to (b) of FIG. 8, a target imaged by the camera 121 is sensed, and the terminal 100 recognizes it as a partial image/video generation event. An indicator 500 indicating that the target is sensed may be output to the display unit 151. The target that may be sensed as a partial image/video generation event may be set in advance in the terminal 100. For example, equipment of an athlete, a cake at a birthday party, a face of a baby may be a target to be imaged that meets a condition for generating a partial image/video generation event.

The partial image/video generation event may include even a change in a target to be imaged. For example, when a target to be imaged becomes close to or distant from the camera 121, a target to be imaged may be added or a target being imaged may disappear. Adding a person (or a character), while a landscape is being captured, may be generation of the partial image/video generation event.

Referring to (c) of FIG. 8, as a target imaged by the camera 121 is sensed, a partial image/video starts to be generated.

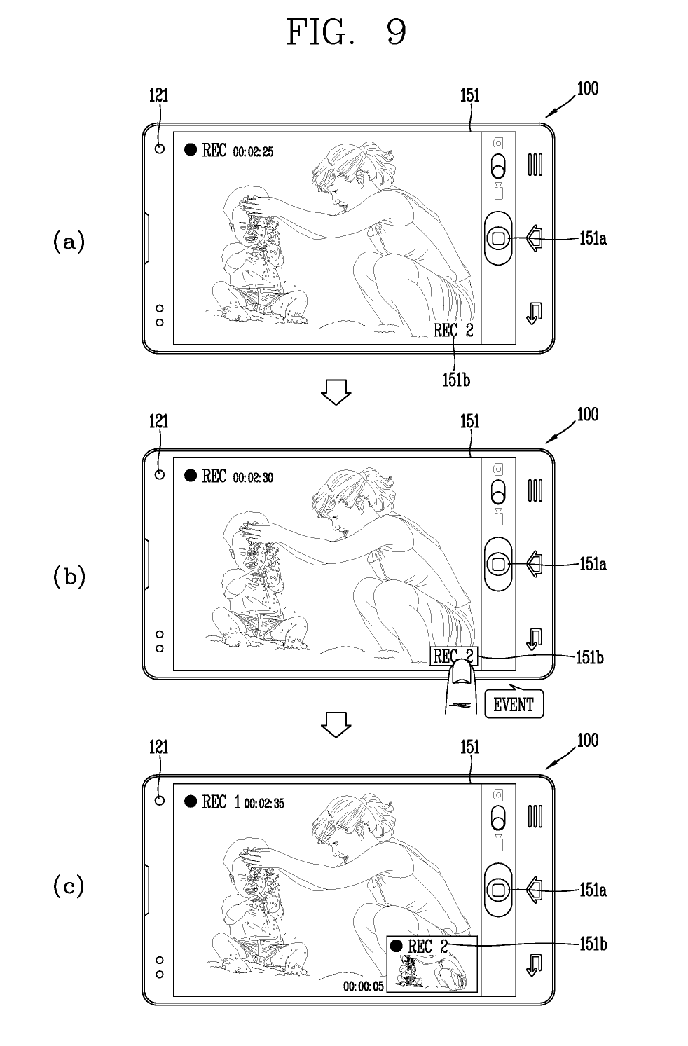

FIG. 9 illustrates an embodiment in which a partial image/video starts to be generated in the terminal 100 on the basis of an input applied to the terminal 100.

Referring to (a) of FIG. 9, video (an entire video) is captured by the camera 121, and video captured by the camera 121 is output to the display unit 151 in real time. A touch input unit 151a for starting or terminating capturing of the entire video and a touch input unit 151b for starting or terminating capturing of a partial image/video are output to the display unit 151.

Referring to (b) of FIG. 9, when a user's touch input is applied to the touch input unit 151b to start capturing of a partial image/video, the controller recognizes it as a partial image/video generation event.

Referring to (c) of FIG. 9, as a user touch input is applied to the touch input unit 151b related to generation of a partial image/video in the terminal 100, a partial image/video starts to be generated. When a user touch input is applied again to the touch input unit 151b, the generation of the partial image/video is terminated.

Since the touch input units 151a and 151b related to the entire video and the partial image/video are output such that they are discriminated from each other, termination of capturing the entire video and termination of the generation of the partial image/video may be independently made. For example, when a touch input is applied to start capturing of a partial image/video, while the entire video is being captured, capturing of a partial image/video starts. Here, capturing of the entire video may be terminated before the generation of the partial image/video is terminated. Capturing of the partial image/video may be continued until when a touch input is applied. Conversely, the generation of the partial image/video may be terminated when capturing of the entire video is terminated according to a setting.

Referring to (a) through (c) of FIG. 9, a capture time of the entire video and a capture time of the partial image/video are output to be discriminated from each other. Thus, the user may check each capture time of the entire video and the partial image/video.

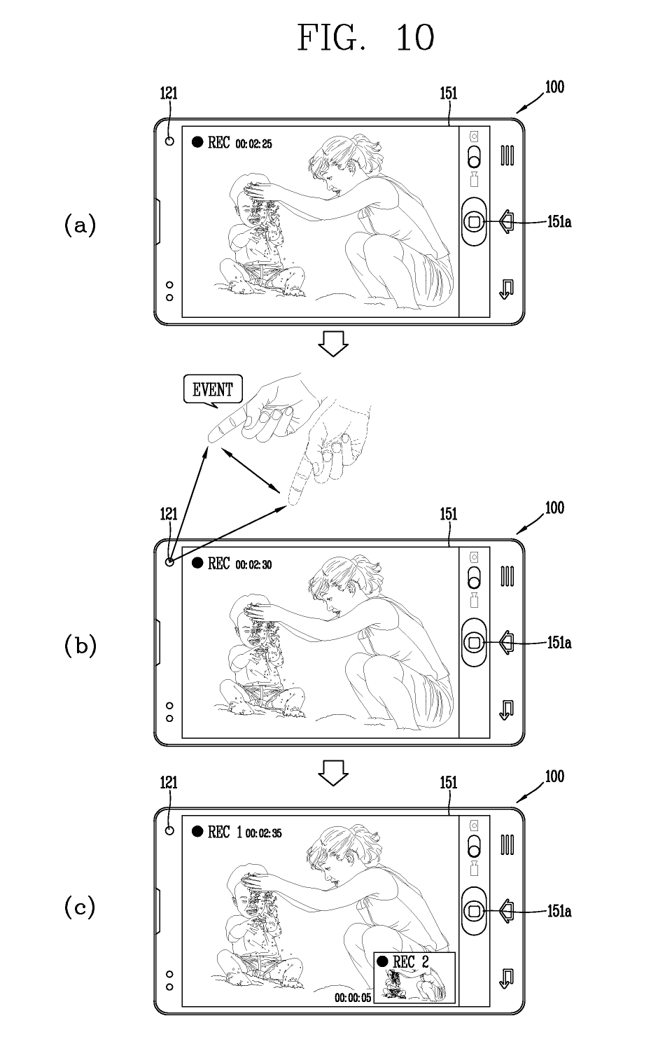

FIG. 10 illustrates another embodiment in which a partial image/video starts to be generated on the basis of an input applied to the terminal 100.

Referring to (a) of FIG. 10, video (an entire video) is captured by the camera 121, and video captured by the camera 121 is output to the display unit 151 in real time. The entire video is captured by a rear camera 121 provided in the rear surface of the terminal 100.

Referring to (b) of FIG. 10, when the user makes a gesture of moving his or her finger, a front camera 121 senses the user's gesture and the controller recognizes it as a partial image/video generation event. The gesture corresponds to a user's input behavior recognized by the camera 121. Capturing of the entire video and recognizing the user's gesture are made by different cameras 121, the user's gesture may not be recorded in the entire video.

The user's gesture corresponding to the partial image/video generation event may not necessarily be sensed by the imaging camera 121 positioned in the opposite side of the camera 121. For example, a pre-set user's gesture may be stored as a partial image/video generation event in the terminal 100, and when the pre-set gesture is sensed by the imaging camera 121, the controller may recognize it as a partial image/video generation event.

Referring to (c) of FIG. 10, as the user's gesture is sensed, a partial image/video starts to be generated.

Hereinafter, the mobile terminal 100 that manages a generated partial image/video and an entire video by discriminating them from one another and a control method thereof will be described.

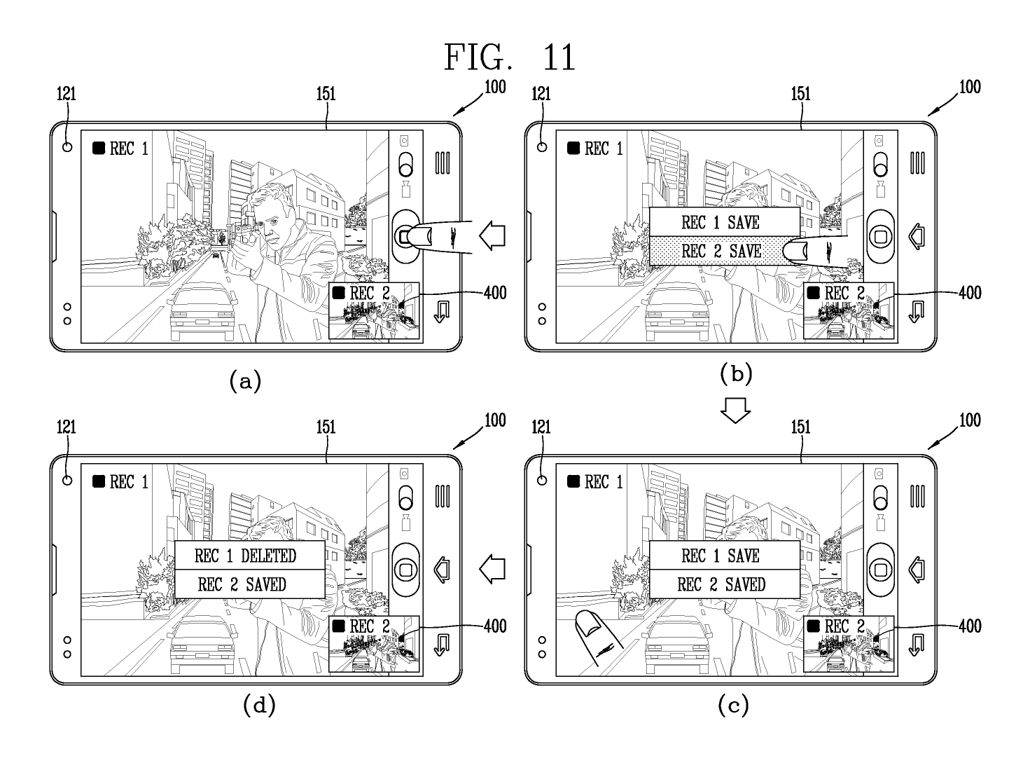

FIGS. 11 through 13 are conceptual views illustrating managing a partial image/video discriminately in isolation from a video captured according to a video capture function.

First, FIG. 11 illustrates an embodiment in which an entire video and a partial image/video are discriminately stored as separate files.

Referring to (a) of FIG. 11, as a touch input for terminating capturing of an entire video is applied, both capturing of the entire video and generation of a partial image/video are terminated.

Referring to (b) of FIG. 11, after the capturing of the entire video and the generation of the partial image/video are terminated, a selection window inquiring whether to store the entire video and the partial image/video is output to the display unit 151. As illustrated, the selection window may be formed to allow for selecting whether to store the entire video REC1 and the partial image/video REC2. The terminal 100 includes a memory for storing an image captured by the camera 121, and the entire video and the partial image/video may be stored as separate files according to a user selection.

FIG. 11(b) illustrates selecting storing of the partial image/video.

Referring to (c) of FIG. 11, it is illustrated that a region other than the selection window is touched, rather than selecting storing of the entire video. Referring to (d) of FIG. 11, as the region other than the selection window is touched, the entire video is deleted, rather than being stored.

Since the entire video and the partial image/video are processed discriminately in isolation from one another, processing of each image does not affect to processing a different image. Thus, only the entire video may be stored, while the partial image/video may not be stored, or vice versa. Both the entire video and the partial image/video may be stored or may be stored as separate files according to a user selection.

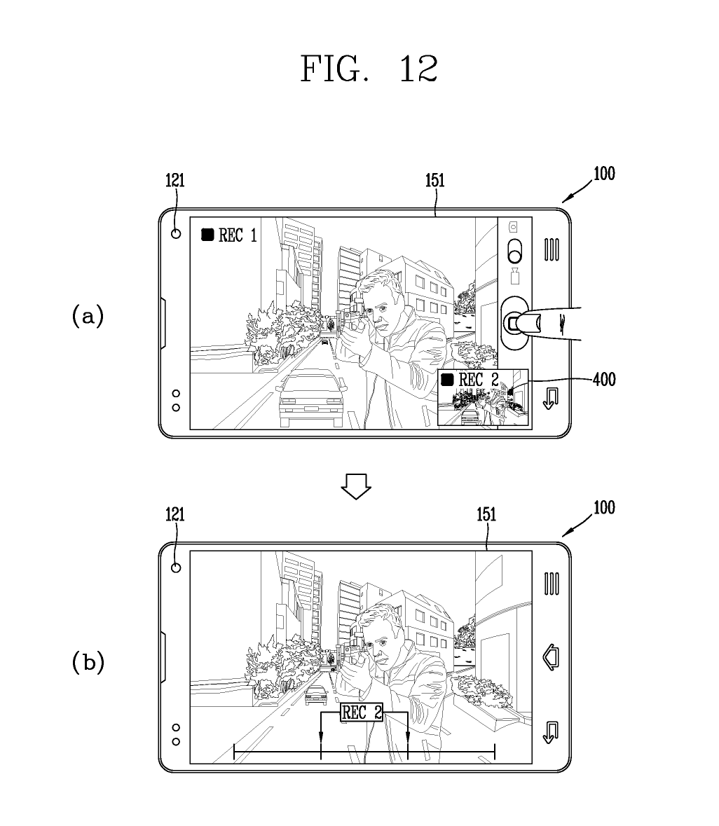

FIG. 12 illustrates an embodiment in which an entire video and a partial image/video are stored as a single file.

Referring to (a) of FIG. 12, when a touch input for terminating capturing of an entire video is applied, both capturing of the entire video and generation of a partial image/video are terminated.

Referring to (b) of FIG. 12, only the entire video is stored without outputting a selection window to the display unit 151, and in this case, information regarding the partial image/video is included in the entire Image and stored. A progress bar indicating an entire section of the entire video is output to the display unit 151, and a section corresponding to the partial image/video may be indicated in the progress bar.

Thus, information regarding the partial image/video processed discriminately in isolation from the entire video by the controller is included in the entire video, and the user may generate the partial image/video from the entire video according to his or her selection anytime by using the information of the partial image/video included in the entire video.

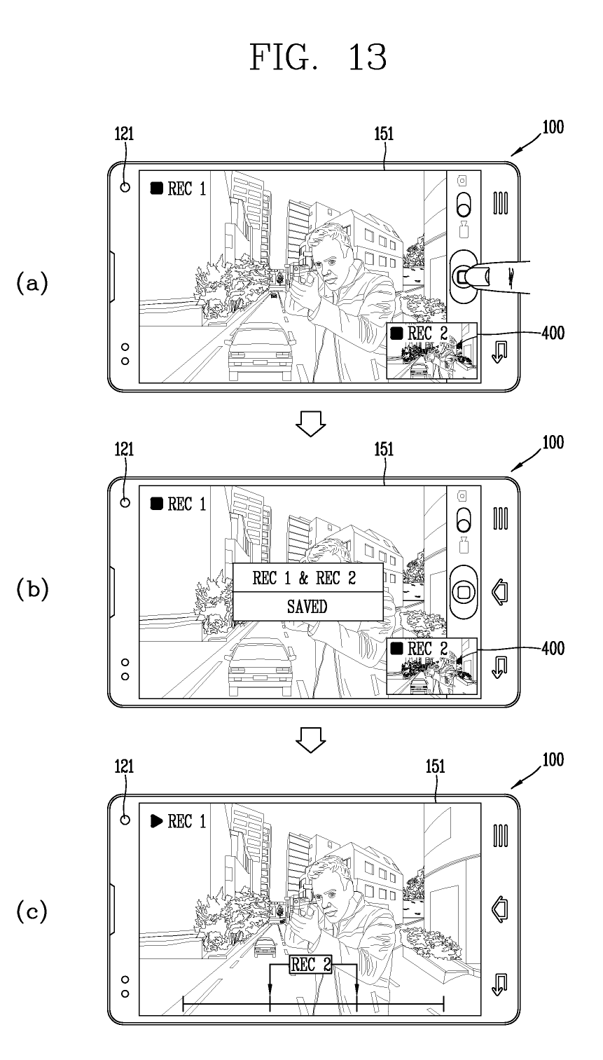

FIG. 13 illustrates an embodiment in which an entire video and a partial image/video are stored as separate files, information of the partial image/video is included in the entire video, and information of the entire video is included in the partial image/video.

Referring to (a) of FIG. 13, when a touch input for terminating capturing of an entire video is applied, both capturing of the entire video and generation of a partial image/video are terminated.

Referring to (b) of FIG. 13, both the entire video and the partial image/video are stored without outputting a selection window to the display unit 151, and information regarding the partial image/video is included in the entire video and stored. Similarly, information regarding the entire video may be included in the partial image/video and stored.

Referring to (b) of FIG. 13, both the entire video and the partial image/video are stored, without outputting a selection window to the display unit 151, and information regarding the partial image/video is included in the entire video and stored. Similarly, information regarding the entire video may be included in the partial image/video and stored.

Referring to (c) of FIG. 13, since the information regarding the partial image/video is included in the entire video, a section corresponding to the partial image/video may be indicated in a progress bar indicating the entire section of the entire video.

Hereinafter, an embodiment related to reproducing a partial image/video will be described.

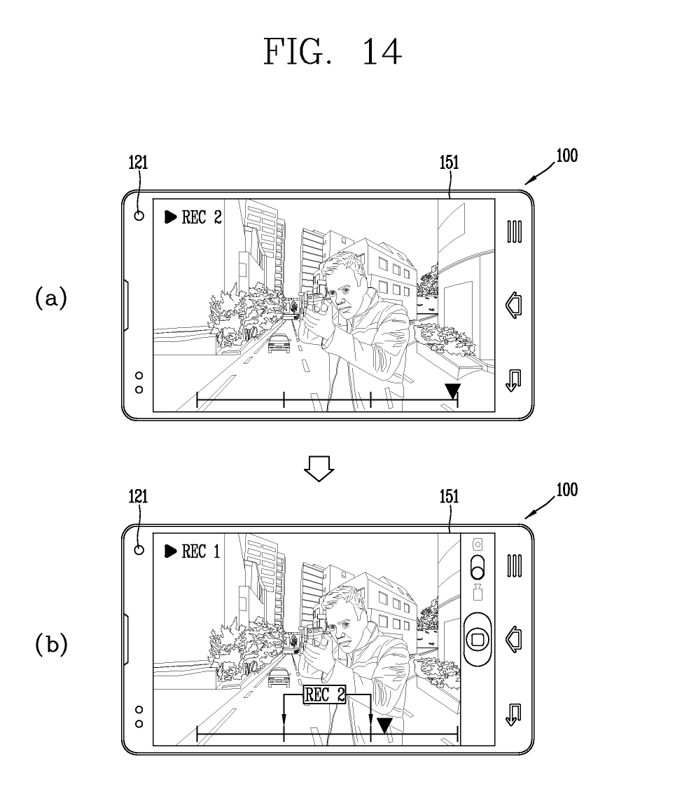

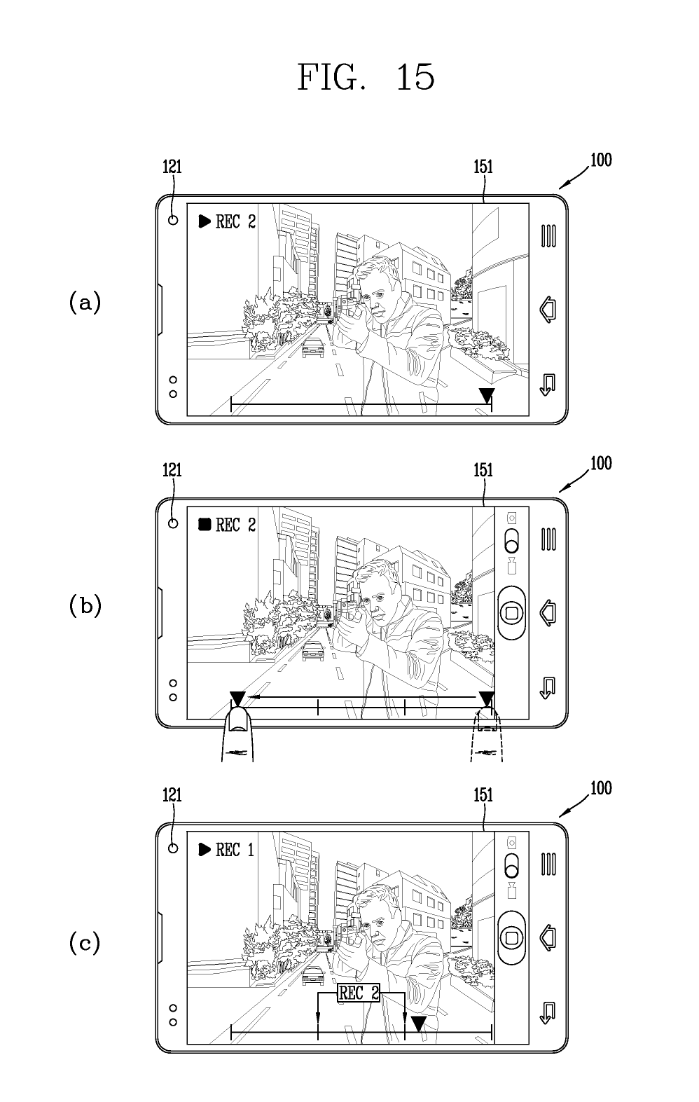

FIGS. 14 and 15 are conceptual views illustrating a process of reproducing video captured according to the video capture function and a partial image/video thereof in an interworking manner.

First, FIG. 14 illustrates an embodiment in an entire video continuously reproduced in succession after a partial image/video is reproduced.

Referring to (a) of FIG. 14, it can be seen that a partial image/video REC2 is being reproduced and a progress bar indicating a reproduction section of the partial image/video indicates that reproducing of the partial image/video is almost completed.

Referring to (b) of FIG. 14, reproducing an entire video REC1 continues in succession after reproducing of the partial image/video is completed even without a user manipulation, and in this case, the reproducing of the entire video may start from a section after the reproducing of the partial image/video is completed. Thus, even in the case in which the partial image/video is reproduced, the terminal 100 may output a rear portion of the partial image/video through the entire video.

FIG. 15 illustrates an embodiment in which reproducing the entire video continues according to a user input related to reproducing of the partial image/video.

Referring to (a) of FIG. 15, it can be seen that the partial image/video REC2 is being reproduced through the display unit 151 and the progress bar indicating a reproduction section of the partial image/video indicates that reproducing of the partial image/video is almost completed.

Referring to (b) of FIG. 15, after reproducing of the partial image/video is terminated, the user may reproduce the entire video by manipulating the progress bar. When the progress bar is moved to the forefront, the entire video may be reproduced in succession. Alternatively, when the progress bar is moved to the end, the entire video may be reproduced, starting from a corresponding section, in succession.

Since the information regarding the entire video is included in the partial image/video and the information regarding the partial image/video is included in the entire video, reproducing of the partial image/video and reproducing of the entire video may interwork.

Hereinafter, an embodiment in which data regarding a partial image/video separately from an entire video is transmitted will be described.

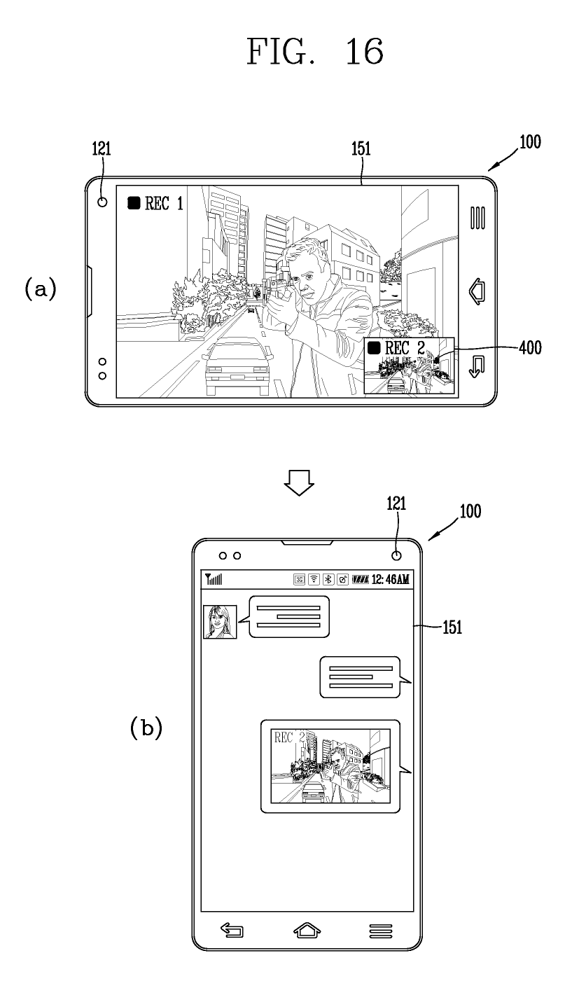

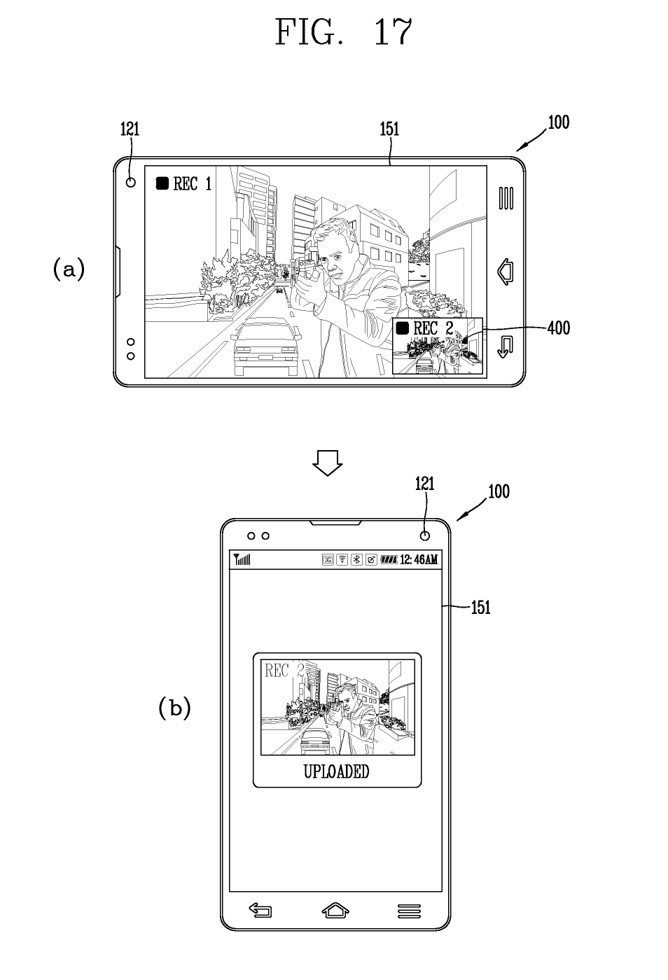

FIGS. 16 and 17 are conceptual views illustrating making use of a partial image/video discriminately in isolation from video captured according to the video capture function.

First, FIG. 16 illustrates an embodiment in which a partial image/video is transmitted to a terminal by using an application such as a mobile messenger.

Referring to (a) of FIG. 16, a partial image/video discriminated from an entire video is generated, and when a user touch input is applied while the entire video is being continuously captured or after the capturing of the entire video is completed, the partial image/video may be transmitted to a terminal.

In particular, in many cases, current wireless communication systems limit a size of data transmittable in mobile. Thus, a partial image/video having data smaller than that of an entire video may be suitable for being transmitted to a terminal by using a wireless communication system.

Referring to (b) of FIG. 16, an embodiment in which the partial image/video is transmitted to an external terminal without editing the entire video is illustrated. In this case, since the partial image/video is automatically generated, an editing process is not required to be performed to generate the partial image/video from the entire video. Here, an image REC2 may be displayed in the transmitted partial image/video. Thus, according to the exemplary embodiment of the present disclosure, there is no need to edit the entire video to have a file size limited in the wireless communication system to share video data with a terminal.

FIG. 17 illustrates an embodiment in which a partial image/video is transmitted to an external server.

Referring to (a) of FIG. 17, a partial image/video discriminated from an entire video is generated, and when a user touch input is applied while the entire video is being continuously captured or after the capturing of the entire video is completed, the partial image/video may be transmitted to an external server.

Referring to (b) of FIG. 17, an embodiment in which the partial image/video is transmitted to the external server, without editing the entire video is illustrated. In this case, an image REC2 may be displayed in the transmitted partial image/video.

The mobile terminal and the control method thereof according to the exemplary embodiments of the present disclosure as described above is not limited in its application of the configurations and methods, but the entirety or a portion of the embodiments can be selectively combined to be configured into various modifications.

According to the exemplary embodiments having the configurations as described above, when a partial image/video generation event occurs while video is being captured, a controller of a terminal processes at least a portion of an image captured after the generation of the partial image/video generation event, as a partial image/video discriminately in isolation from the video. Thus, the partial image/video may be immediately used without having to edit the video after the capturing is completed. Thus, the problem of the related art in which an editing process should be necessarily performed to share image data may be solved.

In addition, video and a partial image/video captured according to a video capture function may be managed discriminately in isolation from each other, and a plurality of partial image/videos may be merged.

Also, since a partial image/video is generated in response to a partial image/video generation event, the partial image/video may be automatically generated and used in a terminal without user intervention.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A mobile terminal comprising:
a camera configured to capture an image; and
a controller configured to control the camera to perform a video capture function, wherein in response to a partial image/video generation event sensed while the video capture function is being performed, the controller processes at least a portion of an image captured by the camera after the sensing of the partial image/video generation event, as a partial image/video discriminated from video being continuously captured according to the video capture function.

2. The mobile terminal of claim 1, wherein the partial image/video is an image captured by the camera in response to the partial image/video generation event, or the video captured by the camera after the partial image/video generation event is sensed.

3. The mobile terminal of claim 1, wherein the video captured according to the video capture function is continuously captured independently from the generation of the partial image/video generation event.

4. The mobile terminal of claim 1, wherein capturing of the partial image/video is terminated regardless of whether the capturing of the video according to the video capture function is terminated.

5. The mobile terminal of claim 1, wherein when sensing of the partial image/video generation event is terminated or when the partial image/video generation termination event is sensed, the capturing of the partial image/video is terminated.

6. The mobile terminal of claim 1, wherein when the capturing of the video according to the video capture function is terminated, the capturing of the partial image/video is also terminated.

7. The mobile terminal of claim 1, further comprising:
a memory configured to store the image captured by the camera,
wherein the video captured according to the video capture function and the partial image/video are stored as separate files in the memory according to a user selection.

8. The mobile terminal of claim 1, wherein the partial image/video generation event comprises a plurality of partial image/video generation events, and
when the plurality of partial image/video generation events are sequentially sensed, the controller processes partial image/videos corresponding to the respective partial image/video generation events discriminately in isolation from each other.

9. The mobile terminal of claim 8, wherein the controller merges the plurality of partial image/videos into a single partial image/video on the basis of a user selection.

10. The mobile terminal of claim 1, wherein the partial image/video generation event comprises an event of a pre-set condition generated in the outside of the terminal.

11. The mobile terminal of claim 1, wherein the partial image/video generation event comprises an input applied to the terminal or a change generated in the terminal.

12. The mobile terminal of claim 1, further comprising:
a display unit configured to output visual information,
wherein the video captured according to the video capture function and the partial image/video are output to the display unit.

13. The mobile terminal of claim 12, wherein the video being continuously captured and the partial image/video are output in an overlapping manner or are output to different regions.

14. The mobile terminal of claim 12, wherein a capture time of the video and a capture time of the partial image/video the display unit are output discriminately while the video and the partial image/video are being continuously captured.

15. The mobile terminal of claim 12, wherein the partial image/video corresponds to a partial section of the video captured according to the video capture function, and
the controller controls the display unit to continuously output the video captured according to the video capture function and the partial image/video.

16. The mobile terminal of claim 12, wherein a section corresponding to the partial image/video is indicated together in a progress bar output to the display unit to indicate an entire section of the video captured according to the video capture function.

17. The mobile terminal of claim 12, wherein when outputting of the partial image/video is terminated, a section of the entire section of the video captured according to the video capture function, that follows the partial image/video, is output in succession to the display unit.

18. A control method of a mobile terminal, the control method comprising:
capturing video through a camera;
sensing a partial image/video generation event that occurs while the video is continuously being captured; and
processing an image captured through the camera after the event is sensed, as a partial image/video discriminated from the video.

19. The control method of claim 18, wherein, in the processing, the video is continuously captured independently from the occurrence of the partial image/video generation event.

20. The control method of claim 18, wherein the partial image/video is an image captured by the camera in response to the partial image/video generation event, or the video captured by the camera after the partial image/video generation event is sensed.

21. The control method of claim 18, wherein, in the processing, storing the video captured according to the video capture function and the partial image/video as separate files in the memory according to a user selection.

22. The control method of claim 18, wherein the partial image/video generation event comprises a plurality of partial image/video generation events, and
when the plurality of partial image/video generation events are sequentially sensed, partial image/videos corresponding to the respective partial image/video generation events are processed discriminately in isolation from each other, in the processing operation.
